(19) United States
(12) Patent Application Publication
(10) Pub. No.: US 2009/0280956 A1
(43) Pub. Date: Nov. 12, 2009

(54) MULTI-GROUP TRANSMISSION OF A MOTOR VEHICLE

(75) Inventors: Alan DITTRICH, Konstanz (DE); Rayk HOFFMANN, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/434,082

(22) Filed: May 1, 2009

(30) Foreign Application Priority Data
May 6, 2008 (DE) 10 2008 001 564.4

(51) Int. Cl. F16H 3/093; F16H 37/00; B60W 10/04; B60W 30/18

(52) U.S. Cl. 477/111; 74/331; 475/207

(57) ABSTRACT

A motor vehicle transmission and method of its operation. The transmission has at least two transmission groups including a way of maintaining traction force during gearshifting operations. Two change-under-load clutches and an intermediate-gear clutch enable traction-force-maintaining gearshifts to be carried out on a splitter group. The first change-under-load clutch has an input connected to a drive motor and an output side to a loose wheel of a first gear constant, the second change-under-load clutch has an input connected to the motor and an output to a loose wheel of the second gear constant. The intermediate-gear clutch has an input connected to the loose wheel of the second gear constant and an output to a shaft of the main group, such that a direct gear can be engaged as an intermediate gear, and the gear constants can be shifted under load by the first and second change-under-load clutches.

### This application claims priority from German patent application serial no. 10 2008 001 564.4 filed May 6, 2008.

### FIELD OF THE INVENTION

The invention concerns a multi-group transmission of a motor vehicle and a method for operating a multi-group transmission of a motor vehicle.

### BACKGROUND OF THE INVENTION

Multi-group transmissions consist of two or more transmission groups, usually arranged in series, the combining of which produces a large number of gears. Increasingly, they are designed as automated gearshift transmissions consisting, for example of an input group, a main group and a downstream range group. Such transmissions are used in particular in utility vehicles since they provide an especially fine gradation of gears, for example with 12 or 16 gears, and are highly efficient. For a smaller number of gears configurations with only a main group and an input group or a main group and a range group are also possible. Furthermore, compared with manual gearshift transmissions they are characterized by high operating comfort and, compared with automatic transmissions, their production and operating costs are particularly economical.

By virtue of their structure conventional multi-group gearshift transmissions, like all manual or automated gearshift transmissions not shifted under load, undergo a traction force interruption during gearshifts since the flow of force from the drive motor is always interrupted by disengaging a clutch in order to disengage the engaged gear without load, to synchronize the transmission and the drive motor in a neutral position to a connection speed, and then to engage the target gear. Since the vehicle is rolling during the traction force interruption undesired speed increases or speed decreases can occur. In addition the fuel consumption can increase. Whereas with passenger motor vehicles the traction force interruption, which affects the driving dynamics, is as a rule perceived only as annoying, for example during upshifts in a driving style of sporty orientation, in the case of heavy utility vehicles the driving speed can be reduced to the point where an upshift is made impossible and, on uphill stretches, undesired downshifts, creep-driving or even additional starting operations may be necessary.

From DE 10 2006 024 370 A1 by the present applicant a traction-force-supported automated multi-group transmission is known with a splitter group as its input or upstream transmission, a main group as its main transmission and a range group as its output or downstream transmission. The structure of this known multi-group transmission with its input transmission and the main transmission enables a direct gear to be engaged as an intermediate gear during a gear change. For this, a direct connection is temporarily formed between an input shaft of the input transmission and a main shaft of the main transmission by means of a change-under-load clutch. This renders the main transmission and the splitter group free from load, so that the engaged gear can be disengaged, the transmission synchronized and the target gear engaged. During this the change-under-load clutch transmits the motor torque to the transmission output, and a dynamic torque that is released during a speed reduction between the original and target gears is used to compensate the traction force interruption to a large extent. The change-under-load clutch can be positioned between the input transmission and the main transmission or between an ordinary starting clutch and the input clutch. The gear ratio of the intermediate gear is determined by the direct connection of the input shaft to the main shaft. Although the starting clutch can remain engaged during the gearshift operation, it is present as a separate starting element.

Moreover, from DE 198 44 783 C1 a method for shifting a gear-change transmission with interlock-type gearwheel clutches is known in which, by means of a gear-synchronizing transmission integrated in the speed-change transmission, optionally by means of a gear stage with ratio i>1 or a gear stage with ratio i<1 a drive connection can be formed between a transmission input shaft and a transmission output shaft. A respective friction clutch is associated with each of the gear stages, which are used during a gearshift operation to adapt the speed of the input shaft to the respective synchronous speed. By controlling the frictional connection between the input and output shafts and/or the drive motor, the speed of the input shaft on the one hand and the torque variation at the output shaft during the gear change on the other hand are influenced. A frictional starting element arranged between the drive motor and the input shaft remains engaged during the gearshift operation. Thus, the gearshift is comparable to a change-under-load. The method can be used, by virtue of a suitable alternating use of the frictional connections via one or the other gear stage of the synchronizing transmission, for upshifts or downshifts in traction and thrust operation.

From EP 1 096 172 A2 an automated change-under-load transmission with unsynchronized gearshift clutches is known. Again, two friction clutches are provided for synchronization. A common flywheel is arranged as a clutch input component between a crankshaft of the drive motor and a transmission input shaft. One synchronization clutch is coupled to the lowest gear stage and used for thrust gearshifts and as a starting element. The other synchronization clutch is coupled to the highest gear stage and used for traction gearshifts. The synchronization clutches are connected on one side via the thrust or traction gears to a transmission output shaft and on the other side via the clutch input component to the transmission input shaft. Synchronization during a gearshift operation, i.e. equalization of the speed of the transmission input shaft with the speed of the gearset of the target gear, takes place by engaging or disengaging the thrust or traction synchronization clutch. During a traction shift the synchronization clutches and the gearshift clutches are actuated in a shift sequence which ensures the transmission of a drive torque to the transmission output shaft, so that the gearshift takes place with no interruption of the traction force. In contrast to the known, traction-force-maintaining, sequentially shifted double clutch transmissions, this transmission also enables shifts, with gear intervals over more than one step, to be carried out.

The two last-mentioned publications each describe a change-speed transmission with change-under-load characteristics. The synchronization clutches described therein are respectively coupled to the lowest and highest gear stage of the change-speed transmission. However, this solution cannot be easily transferred to a multi-group transmission with a number of transmission groups arranged one after another in the force flow, and its shift sequence.

### SUMMARY OF THE INVENTION

Against this background the purpose of the present invention is to indicate a multi-group transmission and a method for operating a multi-group transmission which, with means as simple, inexpensive and space-saving as possible, enable traction-force-maintaining gearshifts to be carried out while ensuring a high level of shift comfort.

The invention is based on the recognition that with simple friction clutches as change-under-load means on an input change-speed transmission and with an intermediate-gear clutch to bridge across a typically unsynchronized basic transmission, all possible shift sequences during traction upshifts or traction downshifts of an automated group change-speed transmission of such type can be carried out while maintaining the traction force and without decoupling the drive input.

Accordingly, the invention starts from a multi-group transmission of a motor vehicle, with at least two transmission groups arranged in the drivetrain, in which means are provided for supporting the traction force during gearshift operations. To achieve the stated objective the invention also provides that on an upstream group made as a gear transmission with a first constant facing toward a drive motor and a second constant facing toward a main group made as a gear transmission, are arranged two change-under-load clutches and an intermediate-gear clutch, such that the first change-under-load clutch is connected on its input side to a driveshaft of the drive motor and on its output side to a loose wheel of the first constant, the second change-under-load is connected on its input side to the driveshaft and on its output side to a loose wheel of the second constant, and the intermediate-gear clutch is connected on its input side to the loose wheel of the second constant and on its output side to a main transmission shaft which is at least actively connected to a transmission output shaft, so that by means of the intermediate-gear clutch in active combination at least with the second change-under-load clutch a direct gear can be engaged as an intermediate gear and by means of the first and second change-under-load clutches the constants of the upstream group can be engaged under load.

A gearshift is understood to mean a shift operation in which an original gear is disengaged and a target gear is engaged, including also the special case in which the target gear is the same as the original gear so that no gear ratio change takes place. An upstream group is also denoted as a splitter transmission or splitter group (GV), a main group also as a main transmission or basic transmission (HG) and a downstream group also as a range transmission or range group (GP).

In addition the invention starts from a method for operating a multi-group transmission of a motor vehicle, with at least two transmission groups arranged in a drivetrain, in which traction force supporting means are activated during a gearshift operation. The stated objective relating to method is achieved in that depending on the original gear engaged and the target gear selected, one or more gearsets of a splitter group and a main group involved in the gear change, on which change-under-load clutches are arranged, are directly shifted under load by means of a change-under-load operation in which one or more of the change-under-load clutches are actuated, so that a force-flow connection between a driveshaft of a drive motor and a main transmission shaft on the drive output side is maintained, and one or more gearsets that cannot be shifted under load and that are involved in the gearshift operation, are shifted while not under load with the help of an intermediate gear engagement in which a direct gear is engaged, via which a direct force-flow connection is formed between the driveshaft and the main transmission shaft, which maintains the traction force.

A preferred multi-group transmission with the traction force maintaining means according to the invention made as change-under-load clutches and the intermediate-gear clutch, comprises three transmission groups arranged one after another in the flow of force, the splitter group and the main group being advantageously designed as countershaft transmissions, and a downstream group being designed as a planetary transmission. The change-under-load clutches and the intermediate-gear clutch are advantageously formed as dry- or wet-operating friction clutches.

Preferably, such a transmission is designed with two countershafts so that the power correspondingly branches via the two countershafts. However, the invention can also be used with advantage in the case of countershaft transmissions with only one countershaft. Likewise, the downstream group mentioned is only present as an example, but is not essential.

In this transmission the upstream group functions as a two-gear splitter transmission with two constants, by means of which the gears of the main group are varied in alternation. The gears so obtained are then multiplied by the downstream group selectively by a planetary gear ratio. Thus, for example, with a three-gear basic transmission, the number of forward gears obtained is n=n_{GV}×n_{HG}×n_{GP}=2×3×2=12.

By virtue of the change-under-load clutches on the gearsets of the splitter group the latter can be shifted under load. The change-under-load clutches replace the usually provided shifting and synchronizing elements of the splitter group and a separate starting element, with the result that costs, structural space and weight are saved. Shift operations in which only the constants of the splitter group are involved, i.e. in particular ones in which no shift processes take place in the basic transmission, can therefore be changed directly under load with a particularly short shift time. To be able also to carry out individual shift operations in the main transmission directly under load, additional change-under-load clutches can be arranged on the corresponding gearsets, for example on a gearset of a 1^{st} gear of the main transmission.

In all other traction-force-supported shift processes, i.e. shifts of gearsets for which no change-under-load clutch is provided, an intermediate gear engagement is provided. In this intermediate gear engagement according to the invention, the driveshaft is connected to the main shaft of the transmission on the output side via the change-under-load clutch of the second constant of the splitter group, i.e. the one facing away from the driveshaft, which is arranged on the loose wheel of the constant, and via the intermediate-gear clutch, which is also arranged on the loose wheel of the second constant but on the main group side. The direct connection between the driveshaft and the main transmission shaft compensates the force flow via the countershafts, which relieves the load on the main transmission and so enables it to be shifted.

An intermediate-gear shift during a gearshift operation preferably takes place in that the intermediate-gear clutch and the change-under-load clutch, operating in a slipping condition, transmit the torque of the drive motor to the main transmission shaft on the output side, while the speed of the drive motor is adapted to a synchronous speed of the target gear, the original gear is disengaged, and when the synchronous speed has been reached the target gear is engaged and the intermediate gear is again disengaged. In principle, in this way traction-force-supported shifts over multiple gear steps are also possible. To shorten the time needed for equalizing the speeds of the driveshaft and target gear, depending on the original gear engaged at the time the change-under-load clutch of the first constant, i.e. the one on the motor side, can be actuated in the engaging or disengaging direction.

In the event that the planetary gearwheels of the downstream range transmission are locked with the sun gear and the ring gear, i.e. the range transmission is rotating at the same speed as the main transmission shaft, the intermediate gear is the direct gear of the transmission as a whole. However, a shift of the range group during a gear change operation is not in itself traction-force-supported. This can be achieved advantageously by arranging further change-under-load means in advance on the range transmission so that a range shift under load is made possible. The intermediate gear can then be engaged with full traction force support, as a direct gear comprising the splitter and main groups varied by the range ratio, i.e. optionally as a direct gear or a ratio gear.

However, it is also possible simply to pass the main transmission shaft axially through the range transmission or downstream group and connect it directly to the transmission output shaft. In this case the intermediate gear automatically becomes the direct gear of the transmission as a whole. If no downstream group is provided, then the main transmission shaft functions at the same time as the transmission output shaft or is connected directly thereto, preferably being made integrally with it.

Thanks to the possible changes-under-load and the intermediate gear engagement, a significant reduction of the speed loss and hence a driving performance improvement is advantageously achieved during all traction shifts, and the shifting and driving comfort is improved. Since the rotating masses to be synchronized can be braked by the intermediate gear, the transmission brake usually provided for braking those masses during upshift processes can be omitted, which further saves or reduces costs, fitting space and weight. In addition, fluctuations and jerky shifts are effectively reduced because the drivetrain is constantly pre-stressed by the intermediate gear during the gearshift operation, whereby the shifting comfort is increased still more.

### BRIEF DESCRIPTION OF THE DRAWINGS

To clarify the invention the description of a drawing with two example embodiments is attached. The drawings show:

FIG. 1: A schematic view of an automated multi-group transmission of a motor vehicle, which changes-under-load and intermediate gear engagement, and

FIG. 2: A schematic view of a second embodiment of an automated multi-group transmission of a motor vehicle, with changes-under-load and intermediate gear engagement

### DETAILED DESCRIPTION OF THE PREFERRED EMBODIMENTS

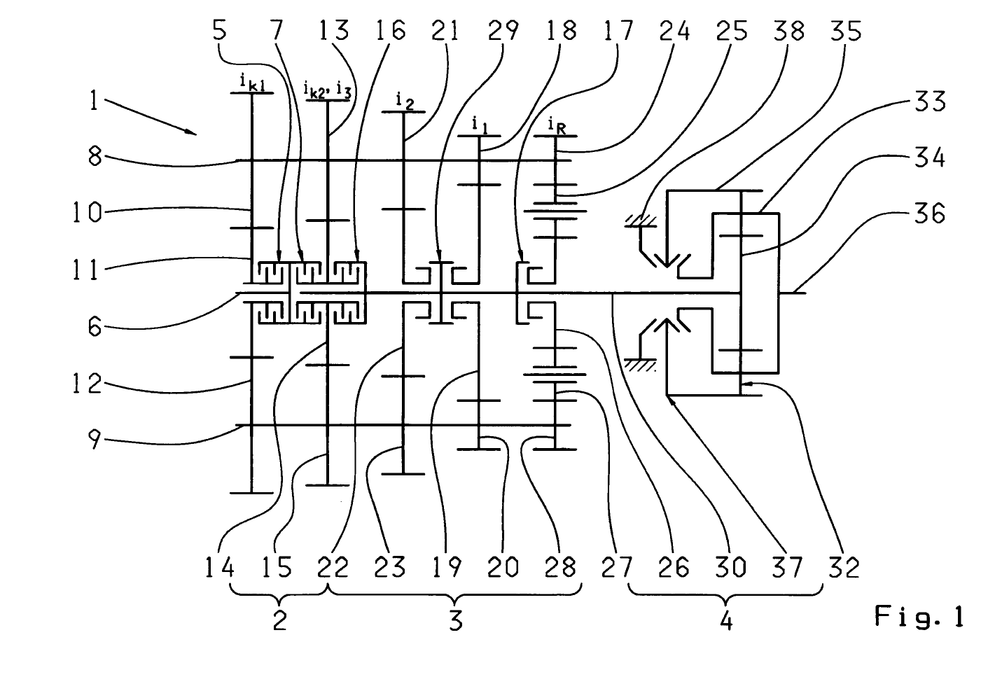

Thus, FIG. 1 shows an automated multi-group transmission designed as a two-countershaft transmission 1 with two parallel, rotating countershafts 8, 9 and three transmission groups, 2, 3 and 4 arranged one after another, as can be provided for example in the drivetrain of a truck. Such a transmission per se, i.e. without traction force support, is known in particular from the ZF-AS Tronic series and with a traction-force-supporting direct gear shift possibility but without a change-under-load splitter group, from DE 10 2006 024 A1 by the present applicant, mentioned at the beginning.

The first transmission group 2, positioned on the engine side, is formed as a two-gear splitter group. The second, central transmission group 3 is formed by a three-gear main or basic transmission. As the third transmission group 4 on the output side, a downstream two-gear range transmission is provided.

The splitter transmission 2 has two gear constants iₖ₁, iₖ₂, each respectively comprising a fixed wheel 10,12 or 13, 15 mounted in a rotationally fixed manner on the first countershaft 8 and on the second countershaft 9, which mesh with a respective loose wheel 11 or 14. The first gear constant iₖ₁ is arranged facing a drive motor (not shown) and the second gear constant iₖ₂ facing the main transmission 3. To shift the two gear constants iₖ₁ and iₖ₂ respective change-under-load clutches 5 or 7, made as friction clutches, are provided, by means of which the loose wheels 11 or 14 can selectively be connected in a rotationally fixed manner to a driveshaft 6 of the drive motor. These two change-under-load clutches 5 and 7 are arranged coaxially to the driveshaft 6 between the loose wheels 11 and 14 facing inward, and are connected on their input side to the driveshaft 6 and on their output side to the respectively associated loose wheel 11 or 14.

By virtue of these change-under-load clutches 5, 7 the splitter transmission 2 can be shifted under load, i.e. it is possible to shift between the gear constants iₖ₁, iₖ₂ without interruption of the drive input. The change-under-load clutches 5, 7 can also be actuated and operated as starting elements. In addition, axially outward and facing the main transmission 3 is also arranged an intermediate-gear clutch 16, again in the form of a friction clutch. The intermediate-gear clutch 16 is connected on its input side to the loose wheel 14 of the second gear constant iₖ₂ and on its output side to a central main transmission shaft 30.

The main transmission 3 has three forward-gear gearsets i, i₂ and i₃ and a reverse-gear gearset i_{R}. The first main transmission gear i₁ and the second main transmission gear i₂ each have two fixed wheels 18, 20 or 21, 24 and a loose wheel 19 or 22. The third main transmission gear i₃ is produced in combination with the second gear constant iₖ₂ of the splitter transmission 2. The reverse-gear gearset i_{R} has two fixed wheels 24, 28, a loose wheel 26 and two freely rotating intermediate wheels 25, 27 to reverse the rotation direction, which mesh on one side with the respective associated fixed wheel 24 or 28 and on the other side with the loose wheel 26.

To engage the first main transmission gear i₁ and the second main transmission gear i₂ an unsynchronized claw-type shifting device 29 is provided, by means of which the appropriate associated loose wheel 19 or 22 can selectively be connected in a rotationally fixed manner to the main transmission shaft 30. The third main transmission gear i₃ is engaged via the intermediate-gear clutch 16, by means of which the loose wheel 14 of the second constant iₖ₂ can be connected in a rotationally fixed manner to the main transmission shaft 30. The reverse-gear gearset has a claw-type shifting device 17 of its own, by which the associated loose wheel 26 can be connected in a rotationally fixed manner to the man transmission shaft 30.

The downstream range transmission 4 is made as a planetary transmission. In it a planetary gearset 32 is carried by a planetary gear carrier 33. The planetary gears mesh on one side with a central sun gear 34 and on the other side with an outer ring gear 35. The sun gear is connected to the main transmission shaft 30. The planetary gear carrier 33, in turn, is connected to a transmission output shaft 36.

To shift the range transmission 4 a shifting device 37, preferably with synchronization, is provided. In a first shift position this shifting device 37 connects the ring gear 35 to a housing 38, so that the planetary gears rotate between the ring gear 35 and the sun gear 34 and in accordance with the gear ratio the transmission output shaft 36 is driven by the planetary gear carrier 33 in the same direction as the main transmission shaft 30. In a second shift position the ring gear 35 is locked to the planetary gear carrier 33, so the planetary transmission 4 and thus the transmission output shaft 36 rotate directly at the speed of the main transmission shaft 30.

From the combination of the transmission groups 2, 3 and 4 in the transmission layout shown, a total of 2×3×2=12 gears are obtained. The force flow of the transmission 1 branches in accordance with a shift sequence in which, beginning with the 1st gear in the main transmission 3, the splitter transmission 2 and the main transmission 3 are first shifted through so that, in sequence, 2×3=6 gears of a lower gear range “1^{st} gear to 6^{th} gear” are engaged. After the 6^{th} gear has been reached the range transmission 4 is shifted over and the main transmission 3 and splitter transmission 2 are again shifted through in alternation, so that again 2×3=6 gears are obtained, but this time in an upper gear range “7^{th} gear to 12^{th} gear”.

When engaging the 5^{th} gear or the 11^{th} gear, the 3^{rd} main transmission gear i₃ is engaged by means of the intermediate-gear clutch 16 and the change-under-load clutch 5 of the first gear constant iₖ₁. When engaging the 6^{th} gear or the 12^{th} gear (6^{th} gear+range group 4 shifted), the 3^{rd} main transmission gear i₃ is engaged by means of the intermediate-gear clutch 16 and the change-under-load clutch 7 of the second constant iₖ₂. This shift situation corresponds to the direct gear, which is also used as the intermediate gear in which the driveshaft 6 is connected directly to the main transmission shaft 30 or the transmission output shaft 36. In this case the direct or intermediate gear is at the same time the highest transmission gear (including the appropriate setting of the range group 6). But if the 11^{th} and 12^{th} gears are designed as fast gears with a gear ratio i<1, the shift sequence can be changed so that already the 10^{th} gear (5^{th} gear+range group 4 shifted) is engaged by means of the intermediate-gear clutch 16 and the change-under-load clutch 7 of the second constant iₖ₂ and is therefore designed as the direct or intermediate gear.

Finally, the splitter transmission 2 also engages the reverse gear ratio in alternation, so that in addition two reverse gears are available.

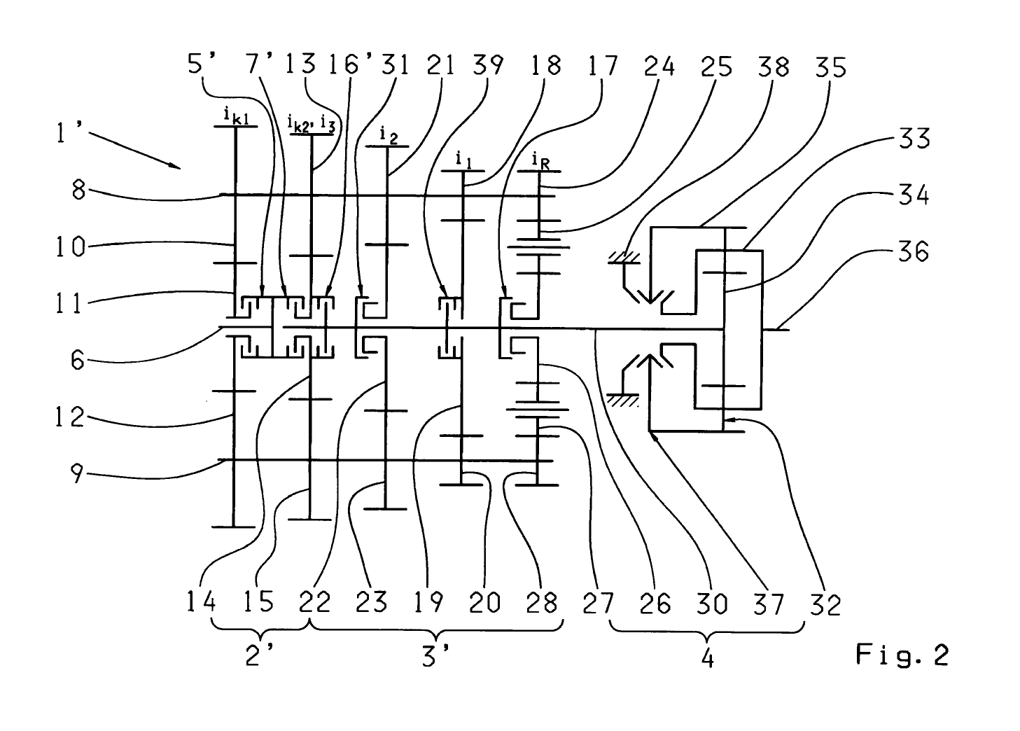

FIG. 2 shows a comparable two-countershaft transmission 1′ with a change-under-load clutch 5′ associated with the first gear constant iₖ₁ of a splitter transmission 2′ and a change-under-load clutch 7′ associated with the second gear constant iₖ₂, and an intermediate-gear clutch 16′. Moreover, an additional change-under-load clutch 39 is provided, which is arranged on the 1st main transmission gear iₖ₂, of a main transmission 3′, the input side of the change-under-load clutch 39 being connected to the associated loose wheel 19 and the output side to the main transmission shaft 30. In this way the 1^{st} main transmission gear i₁ in active connection with the change-under-load clutch 5′ of the splitter transmission 2′ can also be changed directly under load, whereby, including the action of the range group 4, the 1^{st} and 7^{th} gears can additionally be engaged under load.

Depending on the shift process, a method according to the invention for operating the mutli-group transmission described during a gear change is based essentially on engaging an intermediate gear by means of the intermediate-gear clutch 16, 16′ and or on a shift under load using one or more of the change-under-load clutches 5, 5′, 7, 7′, 39, whereby the traction force of the vehicle is maintained.

According to the method, for example in the case of a traction upshift with a shift process in the main transmission 3 or 3′, to engage the direct gear as the intermediate gear the intermediate-gear clutch 16, 16′ and the change-under-load clutch 7, 7′ of the second gear constant iₖ₂ are operated in slipping mode. This transmits the motor torque to the main transmission shaft 30 or directly to the transmission output shaft 36. Consequently the main transmission 3, 3′ becomes load-free and can be shifted. During this torque transmission via the slipping clutches 7, 7′ and 16, 16′ the motor speed is reduced to a synchronous speed of a target gear. The torque released by the speed reduction is used to maintain the traction force. Depending on the original gear (actual gear) engaged, the clutch 5, 5′ of the first gear constant iₖ₁ also participates in the more rapid speed equalization. When the synchronous speed has been reached, the shift from the original gear to the target gear takes place. Finally, depending on the gear change in question, the intermediate-gear, clutch 16, 16′ and/or the first or second change-under-load clutch 5, 5′ or 7, 7′ is/are fully engaged or fully disengaged.

### List of Indexes

1, 1′ Two-countershaft transmission
2, 2′ Upstream group, splitter transmission
3, 3′ Main group, main transmission
Downstream group, range transmission
5, 5′ Change-under-load clutch
6 Driveshaft
7, 7′ Change-under-load clutch
Countershaft
9 Countershaft
10 Fixed wheel
11 Loose wheel
12 Fixed wheel
13 Fixed wheel
14 Loose wheel
15 Fixed wheel
16, 16′ Intermediate-gear clutch
17 Shifting device
18 Fixed wheel
19 Loose wheel
20 Fixed wheel
21 Fixed wheel
22 Loose wheel
23 Fixed wheel
24 Fixed wheel
25 Intermediate wheel
26 Loose wheel
27 Intermediate wheel
28 Fixed wheel
29 Shifting device
30 Main transmission shaft
31 Shifting device
32 Planetary gearset
33 Planetary gear carrier
34 Sun gear
35 Ring gear
36 Transmission output shaft
37 Shifting device
38 Housing
39 Change-under-load clutch
iₖ₁ Splitter group gear constant
iₖ₂ Splitter group gear constant
i₁ Main transmission gear
i₂ Main transmission gear
i₃ Main transmission gear
i_{R} Main transmission reverse gear

1-10. (canceled)

11. A multi-group transmission of a motor vehicle, with at least splitter and transmission groups (2, 2′, 3, 3′) arranged in a drive train, in which means for supporting traction force during gearshift operations are provided, the multi-group transmission comprising the splitter transmission group (2, 2′) with a first gear constant (iₖ₁) facing toward a drive motor and a second gear constant (iₖ₂) facing toward a main transmission group (3, 3′), the splitter transmission group (2, 2′) includes two change-under-load clutches (5, 5′, 7, 7′) and an intermediate-gear clutch (16, 16′), a first change-under-load clutch (5, 5′) being connected, on an input side, to a driveshaft (6) of the drive motor and, on an output side, to a loose wheel (11) of the first gear constant (iₖ₁), a second change-under-load clutch (7, 7′) being connected, on an input side, to the driveshaft (6) of the drive motor and, on an output side, to a loose wheel (14) of the second gear constant (iₖ₂) and the intermediate-gear clutch (16, 16′) being connected, on an input side, to the loose wheel (14) of the second gear constant (iₖ₂) and, on an output side, to a main transmission shaft (30) of the main transmission group (3, 3′) which is at least in active connection with a transmission output shaft (36), such that by the intermediate-gear clutch (16, 16′) in active combination with at least the second change-under-load clutch (7, 7′), a direct gear is engaged as an intermediate gear, and such that the first and the second gear constants (iₖ₁, iₖ₂) of the splitter transmission group (2, 2′) are shiftable under load by the first and the second change-under-load clutches (5, 5′, 7, 7′).

12. The multi-group transmission according to claim 11, wherein the splitter transmission group (2, 2′), the main transmission group, (3, 3′) and a downstream range group (4) are arranged one after another in a flow of force, the splitter transmission group (2, 2′) and the main transmission group (3, 3′) are of countershaft design with at least one common countershaft (8, 9), and the range group (4) is a planetary transmission.

13. The multi-group transmission according to claim 11, wherein at least one further change-under-load clutch (39) is provided and arranged on a gear (i₁) of the main transmission group (3′).

14. The multi-group transmission according to claim 11, wherein the change-under-load clutches (5, 5′, 7, 7′, 39) and the intermediate-gear clutch (16, 16′) are friction clutches.

15. The multi-group transmission according to claim 11, wherein the main transmission shaft (30) is connected directly to the transmission output shaft (36).

16. The multi-group transmission according to claim 11, wherein the range group (4) is shiftable under load.

17. The multi-group transmission according to claim 11, wherein the main transmission shaft (30) passes axially through the range group (4).

18. A method of operating a multi-group transmission of a motor vehicle, with at least two transmission groups (2, 2′, 3, 3′) arranged in a drivetrain, in which means for supporting a traction force, during gearshift operation, is provided, depending on an original gear engaged and a target gear selected, at least one gearset (iₖ₁, iₖ₂, i₁) of a splitter transmission group (2, 2′) and a main transmission group (3, 3′) involved in the gearshift operation, on which change-under-load clutches (5, 5′, 7, 7′, 39) are arranged, are shifted directly under load by a change-under-load operation in which at least one of the change-under-load clutches (5, 5′, 7, 7′, 39) are actuated in such manner that a force-flow connection, between a driveshaft (6) of a drive motor and a main transmission shaft (30) on a drive output side, is maintained, and at least one of the gearsets (i₁, i₂, i₃) that are unchangable under load but which are involved in the gearshift operation, are shifted while free from load by an intermediate gear engagement in which a direct gear is engaged, by which a direct force-flow connection, between the driveshaft (6) and the main transmission shaft (30), is formed so as to maintain the traction flow.

19. The method according to claim 18, further comprising the step of:
engaging an intermediate gear during the gearshift operation, by operating an intermediate-gear clutch (16, 16′) and a change-under-load clutch (7, 7′), arranged on a gear gearset (iₖ₂) of the splitter group (2, 2′), to transmit torque of the drive motor to the main transmission shaft (30) on the output side while a speed of the drive motor is adapted to a synchronous speed of the target gear,
disengaging the original gear is engaged, and
when the synchronous speed of the target gear is reached, engaging the target gear, and
finally again disengaging the intermediate gear.

20. The method according to claim 18, further comprising the step of either engaging or disengaging the change-under-load clutch (5, 5′), associated with a gear constant (iₖ₁) of the splitter group (2, 2′), on the motor side during the synchronization.

21. A multi-group transmission of a motor vehicle comprising:
a splitter transmission group (2,2′) having first and second gear constants (iₖ₁, iₖ₂), first and second change-under-load clutches (5, 5′, 7, 7′) and an intermediate-gear clutch (16, 16′);
the first change-under-load clutch (5,5′) having an input connected to a drive shaft (6) of a drive motor and an output connected to a loose wheel (11) of the first gear constant (iₖ₁);
the second change-under-load clutch (7,7′) having input connected to the drive shaft (6) of the drive motor and output connected to a loose wheel (14) of the second constant (iₖ₂); and
the intermediate-gear clutch (16, 16′) having an input connected to the loose wheel (14) of the second constant (iₖ₂) and an output connected to a main transmission shaft (30) of a main transmission group (3, 3′) which is connected with a transmission output shaft (36), and engagement of the intermediate-gear clutch (16, 16′) and at least the second change-under-load clutch (7, 7′)forms a direct intermediate gear and the first and the second gear constants (iₖ₁, iₖ₂) are shiftable under load by the first and the second change-under-load clutches (5, 5′, 7, 7′).
